(19) United States
(12) Patent Application Publication
(10) Pub. No.: US 2009/0054551 A1
(43) Pub. Date: Feb. 26, 2009

(54) Rubber mixture and tire

(76) Inventors: Steffi Meissner, Rodenberg (DE); Hajo Weinreich, Hessisch Oldendorf (DE); Fabian Dettmer, Braunschweig (DE); Jurgen Wagemann, Bad Salzdetfurth (DE)

Correspondence Address: COLLARD & ROE, P.C., 1077 NORTHERN BOULEVARD, ROSLYN, NY, 11576, US

(21) Appl. No.: 11/919,690

(22) PCT Filed: May 5, 2006
(86) PCT No.: PCT/EP2006/004213

§ 371 Date: Oct. 31, 2007

(30) Foreign Application Priority Data
Jun. 16, 2005 (DE) 10 2005 027 858.2

(51) Int. Cl. C08L 9/00

(52) U.S. Cl. 523/156

(57) ABSTRACT

The invention relates to a rubber mixture that can be cross-linked by sulphur and contains, in order to achieve low-temperature flexibility and high-temperature rigidity, at least one diene rubber, between 5 and 150 phr (weight parts in relation to 100 weight parts of the total rubber mass) of at least one type of soot with an iodine adsorption index >65 g/kg and a DBP index >90 cm³/100 g, and between and 150 phr of a type RAE (residual aromatic extract) crude oil fraction as a softener. The weight ratio of the soot to the crude oil fraction in the mixture is 1:1 to 1:10.

The invention relates to a sulfur-crosslinkable rubber mixture which comprises a diene rubber, carbon black, and plasticizer. The invention further relates to tires, in particular pneumatic tires for vehicles, where the tire tread is at least to some extent based on the sulfur-vulcanized rubber mixture.

With the aim of influencing the properties of the mixture and of the vulcanizate, a very wide variety of additives are admixed with the mixtures, and/or specific polymers are used. Examples that may be mentioned here of additives are fillers (e.g. carbon black), plasticizers, crosslinking systems and antioxidants. However, if the mixture is varied in order to improve one property, there is often an attendant impairment of another property, and there are therefore certain conflicts of objectives here.

It is known that the flexibility of vulcanizates of mixtures can be modified by using specific polymers with various glass transition temperatures, or using various crosslinking systems, or plasticizers (usually aromatic mineral oil plasticizers in the tire industry) and various fillers, in various amounts, whereupon the flexibility is then generally increased or lowered across the entire range of service temperature. An increase in flexibility is then attended by a decrease in stiffness, reflected by way of example in the dynamic modulus E′ at high elongation and at high temperature.

However, a problem often encountered is that a vulcanizate is intended to have high flexibility at low temperatures but to have high stiffness at high temperatures. This is the case, for example, with mixtures for the treads of tires for vehicles, in particular pneumatic tires, the intention here being that, for good winter properties and good braking in wet conditions, these have high low-temperature flexibility, and that, for good handling and braking in dry conditions, they have high-temperature stiffness.

It is therefore an object of the present invention to provide rubber mixtures, in particular for the treads of vehicle tires, whose vulcanizates feature relatively high low-temperature flexibility together with high high-temperature stiffness. The intention is thermal decoupling of vulcanizate flexibility. The results in vehicle tires whose treads are based on this mixture are good winter properties and good braking in wet conditions, and also good handling and good braking in dry conditions.

The invention achieves this object in that the rubber mixture comprises
at least one diene rubber,
from 5 to 150 phr (parts by weight, based on 100 parts by weight of the entire rubber composition) of at least one carbon black whose iodine adsorption number is >65 g/kg and whose DBP number is ≧90 cm³/100 g, and
from 5 to 150 phr of a petroleum fraction of RAE (Residual Aromatic Extract) type, as plasticizer, where the ratio by weight of carbon black to the petroleum fraction in the mixture is from 1:1 to 1:10.

The phr data used in this specification (parts per 100 parts of rubber by weight) are the conventional quantitative data used for mixing the formulations in the rubber industry. The amount added in parts by weight of the individual substances here is always based on 100 parts by weight of the entire mass of all of the rubbers present in the mixture.

Surprisingly, it has been found that the specific combination of 5 to 150 phr of at least one carbon black with high surface area (iodine adsorption number >65 g/kg) and with a high level of structuring (DBP number ≧90 cm³/100 g) with from 5 to 150 phr of a petroleum fraction of RAE (residual aromatic extract) type as plasticizer in a particular ratio in a diene rubber mixture can produce vulcanizates which are dynamically softer at low temperatures, i.e. more flexible, and have good dynamic stiffness at high temperatures. Stiffness and flexibility here can thus be decoupled, and the improvement in one of these properties does not cause impairment of the other. Specific carbon black and the petroleum fraction of RAE type appear to interact synergistically.

The sulfur-crosslinkable rubber mixture comprises at least one diene rubber. Among the diene rubbers are all of the rubbers having an unsaturated carbon chain, where these at least to some extent derive from conjugated dienes. It is particularly preferable that the diene rubber or the diene rubbers has or have been selected from the group consisting of natural rubber (NR), synthetic polyisoprene (IR), polybutadiene (BR), and styrene-butadiene copolymer (SBR). These diene elastomers have good processability to give the inventive rubber mixture and give good tire properties in the vulcanized tires.

The rubber mixture can comprise polyisoprene (IR, NR) as diene rubber. This can be either cis-1,4-polyisoprene or 3,4-polyisoprene. However, preference is given to the use of cis-1,4-polyisoprenes whose cis-1,4 content is >90% by weight. Firstly, this type of polyisoprene can be obtained via stereospecific polymerization in solution using Ziegler-Natta catalysts, or using fine dispersions of alkyllithium compounds. Secondly, natural rubber (NR) is a cis-1,4-polyisoprene of this type, cis-1,4 content in natural rubber being greater than 99% by weight.

If the rubber mixture comprises polybutadiene (BR) as diene rubber, this can be either cis-1,4- or else vinylpolybutadiene (from 40 to 90% by weight of vinyl content). It is preferable to use cis-1,4-polybutadiene whose cis-1,4 content is greater than 90% by weight, and this can, for example, be prepared via solution polymerization in the presence of catalysts of rare-earth type.

The styrene-butadiene copolymer can be solution-polymerized styrene-butadiene copolymer (SSBR) whose styrene content, based on the polymer, is about 10-45% by weight and whose vinyl content (content of 1,2-bonded butadiene, based on the entire polymer) is from 10 to 70% by weight, and this can be prepared, for example, using alkyllithium compounds in organic solvent. The SSBRs can also have been coupled and end-group-modified. However, it is also possible to use emulsion-polymerized styrene-butadiene copolymer (ESBR), or a mixture composed of ESBR and SSBR. The styrene content of the ESBR is about 15-50% by weight, and the types known from the prior art can be used, these having been obtained via copolymerization of styrene and 1,3-butadiene in aqueous emulsion.

The mixture can, however, also comprise other types of rubber in addition to the diene rubbers mentioned, examples being styrene-isoprene-butadiene terpolymer, butyl rubber, halobutyl rubber, or ethylene-propylene-diene rubber (EPDM).

The inventive rubber mixture preferably comprises from 8 to 100 phr of the carbon black(s).

The iodine adsorption number of the specific carbon black (to ASTM D1510) is >65 g/kg, preferably >110 g/kg, and its DBP number (to ASTM D2414) is ≧90 cm³/100 g. Better low-temperature flexibility can be achieved given a relatively high level of structuring or a relatively high surface area. By way of example, carbon blacks of types N-121, N-339, and HV-3396 (Columbian Chemicals Company, USA) can be used.

The rubber mixture can also comprise, as fillers, alongside the specific carbon black, other carbon blacks, silica, aluminum hydroxide, phyllosilicates, chalk, starch, magnesium oxide, titanium dioxide, rubber gels, etc., in any desired combination.

The rubber mixture comprises from 5 to 150 phr, preferably from 15 to 90 phr, of the petroleum fraction of RAE type. Terminology and classification of petroleum fractions is usually in accordance with the American Petroleum Institute. The petroleum fraction of type RAE, which has not hitherto been used in the tire industry, is the petroleum fraction from solvent extraction of vacuum-destillate residues comprising saturated and unsaturated hydrocarbons, mainly >C₂₅ (“streams obtained from the solvent extraction of vacuum residues, and containing saturated and aromatic hydrocarbons, mainly in the range >C₂₅”). By way of example, it is possible to use FLAVEX 595 from the company Shell. Another advantage of petroleum fractions of RAE type is they are not subject to identification-marking requirements.

The rubber mixture can comprise, alongside the abovementioned ingredients, further additives conventional in the rubber industry, e.g. further plasticizers, antioxidants, activators, for example zinc oxide, and fatty acids (e.g. stearic acid), waxes, resins, silane coupling agents, and mastication auxiliaries, in conventional parts-by-weight amounts.

Vulcanization is carried out in the presence of sulfur or of sulfur donors, and some sulfur donors can act simultaneously as vulcanization accelerators here. Sulfur or sulfur donors are added to the rubber mixture in the final mixing step in the amounts familiar to the person) skilled in the art (from 0.4 to 4 phr, sulfur preferably in amounts of from 1.5 to 2.5 phr).

The rubber mixture can moreover comprise substances that influence vulcanization, e.g. vulcanization accelerators, vulcanization retarders, and vulcanizer activators, in conventional amounts, in order to control the time required and/or the temperature required for the vulcanization process, and in order to improve vulcanizate properties. The vulcanization accelerators here can, for example, have been selected from the following accelerator groups: thiazole accelerators, e.g. 2-mercaptobenzothiazole, sulfenamide accelerators, e.g. benzothiazyl-2-cyclohexylsulfenamide (CBS), guanidine accelerators, e.g. N,N′-diphenylguanidine (DPG), dithiocarbamate accelerators, e.g. zinc dibenzyldithiocarbamate, disulfide. The accelerators can also be used in combination with one another, whereupon synergistic effects can arise.

The inventive rubber mixture is prepared conventionally, by generally first preparing a parent mixture which comprises all of the constituents with the exception of the vulcanization system (sulfur and substances influencing vulcanization), in one or more stages of mixing, and then producing the finished mixture via addition of the vulcanization system. The mixture is then further processed, e.g. via an extrusion procedure, and converted to the appropriate form, e.g. the form of a green tread. A green product produced in this way from a tread mixture is applied in the known manner during production of the green pneumatic tire for a vehicle. A wind-on process can also be used, using the tread in the form of a narrow strip of rubber.

The vulcanizates have good low-temperature flexibility together with good high-temperature stiffness. When pneumatic tires for vehicles have a tread composed of this type of mixture they have good winter properties, i.e. good traction on icy and snowy ground, and good braking in wet conditions, together with good handling properties and good braking in dry conditions.

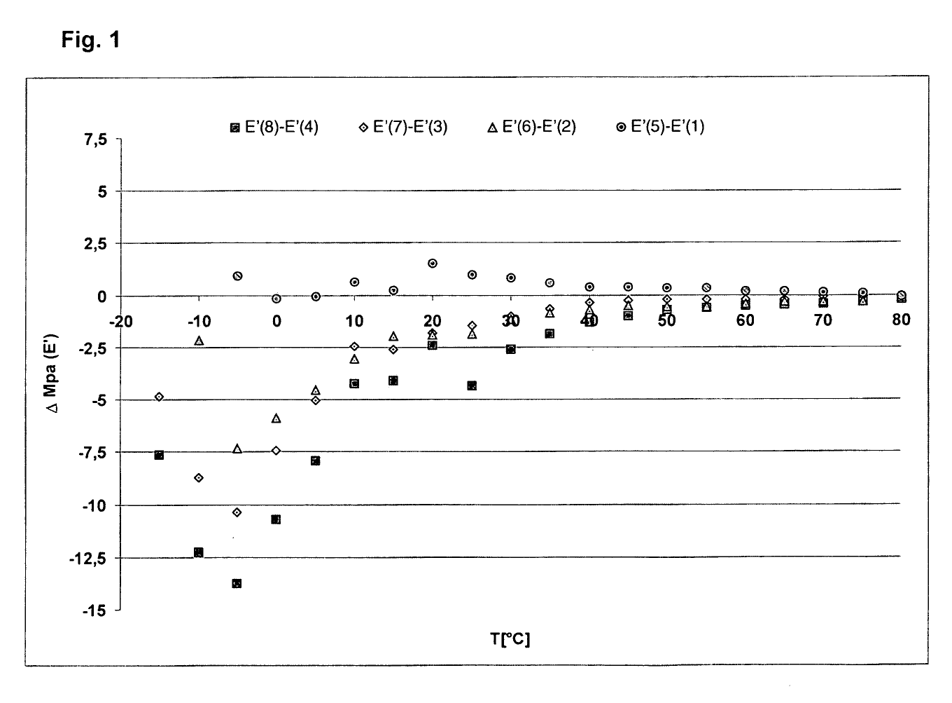

The invention will now be further illustrated using comparative and inventive examples, collated in table 1 and FIG. 1.

In the case of the examples of mixtures found in table 1, the stated quantitative data are parts by weight based on 100 total parts by weight of rubber (phr). The comparative mixtures are characterized by V, and the inventive mixtures are characterized by E. The mixtures in table 1 differ only in the carbon black used and in the oil used, and the other constituents of the mixture remain unchanged. Addition of the carbon black in all of the mixtures was such as to give almost identical Shore A hardnesses at room temperature for the vulcanizates.

The mixture was prepared under conventional conditions in two stages in a laboratory tangential mixer. Test specimens were produced from all of the mixtures via 20 minutes of vulcanization under pressure at 160° C., and these test specimens were used to determine typical rubber-industry properties of the materials, which have been listed in table 1. The following test methods were used for testing the test specimens:
stress values at 200% elongation at room temperature to DIN 53 504
Shore A hardness at room temperature and 70° C. to DIN 53 505
dynamic storage modulus E′ to DIN 53 513 from measurement with constant stress amplitude of 50±30 N at frequency of 10 Hz from −20° C. to 80° C. in steps of 5 K (absolute E′ values at −5° C. and at 80° C. have been listed by way of example in table 1)

TABLE 1

| Constituents | Unit | I(V) | 2(V) | 3(V) | 4(V) | 5(V) | 6(E) | 7(E) | 8(E) |
|---|---|---|---|---|---|---|---|---|---|
| BR^{a} | phr | 30 | 30 | 30 | 30 | 30 | 30 | 30 | 30 |
| SSBR^{b} | phr | 70 | 70 | 70 | 70 | 70 | 70 | 70 | 70 |
| N-660^{c} | phe | 86 | — | — | — | 86 | — | — | — |
| carbon black | | | | | | | | | |
| N-339^{d} | phr | — | 58 | — | — | — | 58 | — | — |
| carbon black | | | | | | | | | |
| N-121^{e} | phr | — | — | 50 | — | — | — | 50 | — |
| carbon black | | | | | | | | | |
| HV-3396^{f} | phr | — | — | — | 50 | — | — | — | 50 |
| carbon black | | | | | | | | | |
| Silica | phr | 50 | 50 | 50 | 50 | 50 | 50 | 50 | 50 |
| Aromatic | phr | 55 | 55 | 55 | 55 | — | — | — | — |
| mineral oil | | | | | | | | | |
| plasticizer | | | | | | | | | |
| RAE^{g} | phr | — | — | — | — | 55 | 55 | 55 | 55 |
| Antioxidant | phr | 2 | 2 | 2 | 2 | 2 | 2 | 2 | 2 |
| Antiozonant | phr | 2 | 2 | 2 | 2 | 2 | 2 | 2 | 2 |
| wax | | | | | | | | | |
| Zinc oxide | phr | 3 | 3 | 3 | 3 | 3 | 3 | 3 | 3 |
| Stearic acid | phr | 2 | 2 | 2 | 2 | 2 | 2 | 2 | 2 |
| Silane | phr | 5 | 5 | 5 | 5 | 5 | 5 | 5 | 5 |
| coupling | | | | | | | | | |
| agent | | | | | | | | | |
| Accelerator | phr | 3.3 | 3.3 | 3.3 | 3.3 | 3.3 | 3.3 | 3.3 | 3.3 |
| Sulfur | phr | 2 | 2 | 2 | 2 | 2 | 2 | 2 | 2 |
| Properties | | | | | | | | | |
| 200% | N/mm² | 7.8 | 6.03 | 4.98 | 4.44 | 8.0 | 6.27 | 5.02 | 4.27 |
| stress | | | | | | | | | |
| value | | | | | | | | | |
| Hardness | Shore A | 71 | 70 | 69 | 69 | 70 | 70 | 68 | 68 |
| ar RT | | | | | | | | | |
| Hardness | Shore A | 65 | 63 | 60 | 59 | 65 | 63 | 60 | 59 |
| at 70° C. | | | | | | | | | |
| E′ at −5° C. | MPa | 54 | 83 | 73 | 97 | 55 | 76 | 63 | 84 |
| E′ at 80° | MPa | 6.707 | 7.120 | 6.142 | 6.113 | 6.699 | 7.090 | 6.211 | 6.142 |

^{a}high-cis polybutadiene
^{b}solution-polymerized styrene-butadiene copolymer, styrene content: 25% by weight, vinyl content 50%
^{c}iodine adsorption number = 50 g/kg and DBP number = 90 cm³/100 g
^{d}iodine adsorption number = 120 g/kg and DBP number = 90 cm³/100 g
^{e}iodine adsorption number = 120 g/kg and DBP number = 130 cm³/100 g
^{f}iodine adsorption number = 165 g/kg and DBP number = 125 cm³/100 g
^{g}FLAVEX 595 from the company Shell; density at 15° C.: 980 kg/m³ (to ISO 12185), refractive index at 20° C.: 1.55 (to ASTM D1218), pour point: 15° C. (to ISO 3016), kinematic viscosity at 40° C.: 3300 mmm²/s (to ISO 3104), viscosity-density constant: 0.916 (to DIN 51378), sulfur content: 4% bby weight (to ISO 14596), content of hydrocarbons, sulfur-corrected (to DIN 51378): aromatic
C_{A}: 29%, naphthenic
C_{N}: 15%, paraffinic
C_{P}: 56%,
refractive intercept: 1.060 (to DIN 51378).

The dynamic modulus E′ at 80° C. correlates with the high-temperature stiffness of the vulcanizates under load, larger E′ values meaning higher stiffness. High dynamic modulus E′ under these conditions is considered to be an indicator of good handling potential of the mixture and good braking performance in dry conditions for use in tires. The smaller the dynamic modulus E′ at low temperatures, the higher the low-temperature flexibility of the vulcanizates. In the case of tires, a small dynamic modulus E′ at −5° C. is attended by good winter properties and good braking in wet conditions.

From table 1 it can be seen that it is only the specific combination of carbon black whose iodine adsorption number is >65 g/kg and whose DBP number is ≧90 cm³/100 g with the petroleum fraction of RAE type that gives an improvement in low-temperature flexibility of the vulcanizates without impairment of high-temperature stiffness. The improvement is particularly clear in comparison with mixtures which comprise an aromatic mineral oil plasticizer, as shown in FIG. 1
which shows a plot in which the difference between the dynamic moduli E′ (ΔE′) of the mixtures with RAE and those with aromatic oil (E′ of 5(V)−E′ of 1(V), E′ of 6(E)−E′ of 2(V), etc.) has been plotted against temperature.

Again from FIG. 1 it is clear that use of the inventive mixtures reduces the dynamic modulus E′ when comparison is made with the mixtures with aromatic mineral oil plasticizer or the mixture with carbon black of type N-660, in the temperature range below about 30° C. However, in the range above 30° C. the dynamic modulus E′ for the mixtures is approximately equal, indicating no impairment of high-temperature stiffness.

1. A sulfur-crosslinkable rubber mixture, comprising
at least one diene rubber,
from 5 to 150 phr (parts by weight, based on 100 parts by weight of the entire rubber composition) of at least one carbon black whose iodine adsorption number is >65 g/kg and whose DBP number is ≧90 cm³/100 g, and
from 5 to 150 phr of a petroleum fraction of RAE (residual aromatic extract) type, as plasticizer,
where the ratio by weight of carbon black to the petroleum fraction in the mixture is from 1:1 to 1:10.

2. The rubber mixture as claimed in claim 1, wherein it comprises from 8 to 100 phr of the carbon black.

3. The rubber mixture as claimed in claim 1, wherein the iodine adsorption number of the carbon black is >110 g/kg.

4. The rubber mixture as claimed in claim 1, wherein it comprises from 15 to 90 phr of the petroleum fraction of RAE type.

5. A tire, in particular a pneumatic tire for a vehicle, where at least to some extent the tire tread is based on a sulfur-vulcanized rubber mixture as claimed in claim 1.
